(19) United States
(12) Patent Application Publication
(10) Pub. No.: US 2026/0336194 A1
(43) Pub. Date: Oct. 29, 2026

(54) DEVICE FOR TRANSPORTING AND GRIPPING A PREFORM IN A THERMAL CONDITIONING UNIT AND CLAMP CAPABLE OF CO-OPERATING WITH A GRIPPING DEVICE

(71) Applicant: SIDEL PARTICIPATIONS, Octeville-sur-Mer (FR)

(72) Inventors: Philippe FREIRE-DIAZ, OCTEVILLE-SUR-MER (FR); Marie-Alix FAURE, OCTEVILLE-SUR-MER (FR)

(21) Appl. No.: 19/107,768

(22) PCT Filed: Aug. 9, 2023
(86) PCT No.: PCT/EP2023/072040

§ 371 Date: Feb. 28, 2025

(30) Foreign Application Priority Data
Sep. 2, 2022 (FR) FR2208825

(51) Int. Cl. B29C 49/42; B29C 49/68

(52) U.S. Cl. CPC B29C 49/42085; B29C 49/685

(57) ABSTRACT

Provided is a device for gripping a preform of a container in a thermal conditioning unit. The device includes a holder, a mandrel mounted in the holder, a spinner mounted on the free end of the mandrel, and an ejector. The ejector has a substantially tubular shape and one of the ends has at least one ejection surface of the preform and a removable fastening means having a jaw attached to the ejector and/or to the holder. Each jaw has male or female means that are capable of co-operating with complementary female or male means attached to the holder or to the ejector, and at least one elastic means that is capable of maintaining the male or female means of the jaws in a locking position in the female or male means of the holder or the ejector.

### CROSS-REFERENCE TO RELATED APPLICATIONS

This application is a 371 U.S. National Stage Application of PCT Application Serial Number PCT/EP2023/072040 filed on Aug. 9, 2023, which application claims the benefit of and priority to French Application No. FR 2208825, filed Sep. 2, 2022, the entire contents of each of which are hereby incorporated herein by reference.

### TECHNICAL FIELD OF THE INVENTION

The invention relates to a device for conveying and gripping a tubular preform with rotation of the preform about its main axis, more particularly in a thermal conditioning unit, and to a clamp adapted and intended to be rigidly secured to a robotic arm and to interact with a gripping device according to the invention, and to a method for mounting and/or dismantling at least one spinner nose of a gripping device according to the invention.

The invention relates to the field of manufacturing of hollow bodies made of thermoplastic material, manufacturing for which a preform is first produced by injection molding. The preform is then formed into a container in a container manufacturing facility.

To this end, the container manufacturing facility comprises a thermal conditioning unit, also referred to as an oven, in which the preform is thermally conditioned, and a blow molding unit for obtaining the final container, in which the preform is formed by blow molding or by stretch blow molding.

The term “hollow body” means a preform of a container, or a final container, or possibly an intermediate container, in other words any type of hollow body comprising a body from which a protruding tubular neck extends.

In the remainder of the document, the term “preform” will preferably be used, without this being limiting.

The preform generally has a tubular cylindrical body which is closed at one of its axial ends and which is extended at its other end by a neck, also tubular.

The neck extends axially from an annular main collar which is arranged at the junction of the neck and the body of the preform, to an annular lip also referred to as a rim, which delimits an axial opening of the neck.

The body of the preform is required to undergo plastic deformation to form the final container during the blow molding operation. In order to carry out this blow molding operation, it is necessary for the body of the preform to be brought to a temperature higher than the glass transition temperature of the material. For this purpose, thermal conditioning of the preform is carried out by circulating the preform inside an oven, using a conveyor following a heating path. The oven comprises heating means which are for example composed of infrared bulbs or laser diodes in front of which the preforms move by virtue of the conveyor.

When moving in the oven, the preform is advantageously rotated about its main axis in order to heat it uniformly.

The preforms are usually held on the conveyor by gripping means.

The preform is transferred, or loaded, at the oven inlet by means for transferring the preform from a preform feed device to the conveyor.

The operation of gripping a preform using gripping devices is known in French as “vêtissage”, and will be called “loading” herein.

Similarly, at the oven outlet, the operation of unloading the heated preform from the gripping devices is known in French as “dêvêtissage”, and will be called “unloading” herein.

Conventionally, the gripping devices grip the preforms on the inside of the neck using gripping means. The gripping means is thus driven by a vertical movement downward along the main axis of the preform relative to the transfer means in order to allow the insertion of the gripping means into the neck. For this purpose, the conveyors travel above the transfer means.

By contrast, the gripping device is separated from the preforms by virtue of the bearing of an ejection face of the ejector on the rim of the preform and the upward movement of the gripping means along the main axis of the preform relative to the transfer means in order to allow the separation of the gripping means from the neck.

The path of a preform carried by the transfer means is generally tangent to the path of the conveyors at one point or, at best, the two paths are superimposed over a short distance. This area of overlap at one point or over a short distance is referred to below as the “loading area”.

In order for the loading operation to take place, the gripping means must be synchronized with the transfer means so that the gripping means are actuated exactly in line with the loading area.

Similarly, for the unloading operation to take place, the gripping means must be synchronized with the transfer means so that the gripping means are actuated exactly in line with the unloading area.

Such gripping means are well known. See, in particular, European patent EP0935572which describes a device for conveying and gripping preforms.

Said gripping device comprises:
a support with a vertical axis;
a mandrel with an axis mounted pivotably slidingly relative to the support with a vertical axis, said vertical axis being coaxial with the axis of the mandrel;
a spinner mounted on one end of the mandrel, and which includes:
a spinner nose removably attached to one end of the mandrel and capable of gripping a preform;
an ejector at least partially surrounding the spinner nose, is rigidly secured to the support with a vertical axis by an attachment means and capable of ejecting a preform.

The same facility must be suitable for the manufacture of containers of different models, and in particular of different capacities. A given model of preform may be suitable for several models of container, but not all. The oven must also be able to heat different models of preform.

Preforms are distinguished not only by the shapes (and sizes) of their bodies, but sometimes have necks of different diameters.

Clearly, therefore, it is then necessary to replace each spinner nose with another, of a diameter adapted to the new model of preform to be heated.

The spinner nose is usually attached on the mandrel by means of a bayonet. This bayonet commonly takes the form of a groove made in the mandrel, in which a pin rigidly secured to the spinner nose engages. To dismantle the spinner nose, it is necessary to disengage the pin from the bayonet.

However, it is necessary to first remove the ejector because it hinders access to the part of the spinner nose via which it is attached to the mandrel.

However, the total sequence of operations required to dismantle the ejector is quite long.

To be specific, whether or not dismantling of the ejector is automated, it still needs to be simplified. This is the aim of the invention.

### SUMMARY OF THE INVENTION

The invention proposes, according to a first subject, a gripping device for gripping a preform of a container made of thermoplastic material in a thermal conditioning unit, which comprises at least:
a support with a hole of vertical axis;
a mandrel with an axis of revolution, a first end of which is mounted in the hole of the support via a connection pivotably slidingly relative to said support, said vertical axis of the support and the axis of the mandrel thus being coaxial;
a spinner mounted on the free opposite end of the mandrel, and which comprises at least:
   a spinner nose rigidly secured removably to the free end of the mandrel, said spinner nose being intended to receive the neck of the preform;
   an ejector rigidly secured to the support by removable attachment means, the mandrel and the spinner nose extending coaxially with the ejector in such a way that the free end of the spinner nose projects from said ejector, said ejector having a substantially tubular shape and comprising at one of its ends at least one surface referred to as an ejection surface for ejecting said preform.

The gripping device according to the invention is characterized in that said removable attachment means comprise at least one jaw rigidly secured to the ejector and/or to the support, each jaw comprising male or female means adapted to interact with complementary female or male means rigidly secured to the support or respectively to the ejector, and at least one elastic means adapted to keep the male or female means of the jaws in a position, referred to as the locking position, in the female or male means of the support or respectively of the ejector.

According to another aspect of the invention, each jaw pivots about an articulation axis orthogonal to the mandrel of axis of revolution.

According to another aspect of the invention, said jaw extends in a housing made in a peripheral wall of the ejector or the support when said jaw is in the position referred to as the locking position, all or part of said jaw projecting from said housing in the position referred to as the unlocking position.

According to another aspect of the invention, the two jaws are diametrically opposite one another.

According to another aspect of the invention, each jaw comprises a first part and a second part extending on either side of the articulation axis, said first part comprising said male or female means adapted to interact with complementary female or male means rigidly secured to the support or to the ejector and said second part comprising a surface referred to as the actuating surface such that, by exerting pressure on and/or releasing said pressure on the actuating surface, each jaw passes from its unlocking position to its locking position and vice versa.

According to another aspect of the invention, the elastic return means is an O-ring or a coiled annular spring or a torsion spring.

According to another aspect of the invention, a part of said elastic return means bears in a groove made in the peripheral wall of the ejector or the support.

The invention proposes, according to a second subject, a clamp adapted and intended to be rigidly secured to a robotic arm and to interact with a gripping device.

The clamp according to the invention is characterized in that it comprises at least two branches referred to as main branches that are movable relative to one another and rigidly secured to at least one movable component of an actuator, each main branch comprising first means referred to as gripping means adapted to grip said spinner nose and second means referred to as gripping means adapted to interact with said jaws of the attachment means of the gripping device to move the jaws from their locking position to an unlocking position.

According to another aspect of the invention, the gripping means of each main branch comprise a secondary branch extending from the main branch toward the second main branch, the free end of the secondary branch being adapted to bear on the spinner nose so as to grip the latter.

According to another aspect of the invention, the free end of each secondary branch is provided with an elastomer tip.

According to another aspect of the invention, said tip is rigidly secured removably to the free end of each secondary branch.

According to another aspect of the invention, the second gripping means of each main branch comprise a pusher adapted to actuate the jaws of the attachment means of the gripping device.

According to another aspect of the invention, the second gripping means of each main branch comprise at least one pad referred to as an ejector pad to which said pusher is rigidly secured, said ejector pad being adapted to grip said ejector.

According to another aspect of the invention, the pusher is rigidly secured to the ejector pad in such a way that it actuates the jaw simultaneously when the ejector is gripped by the ejector pad.

According to another aspect of the invention, said pusher comprises a rod extending parallel to the secondary branch and adapted to move parallel to the latter, the free end of said pusher comprising a surface adapted to bear on the corresponding jaw of the attachment means of the gripping device.

According to another aspect of the invention, said rod extends through a hole made in the main branch, an elastic means being positioned between the main branch and the pad to dampen the movement of the pusher.

According to another aspect of the invention, said elastic means consists of a helical spring extending around the rod and of which a first end bears on the main branch and of which the opposite end bears on the pad.

According to another aspect of the invention, the second gripping means comprise two guides extending parallel to the rod, on either side of the latter, rigidly secured to the main branch and along which the ejector pad is adapted to slide.

The invention proposes, according to a third subject, a method for dismantling at least one spinner nose of a gripping device according to the invention comprising at least the following operations:
gripping the spinner nose of the gripping device to block it in rotation and in translation along its axis of revolution;
actuating the jaws of the gripping device to move them from their locking position to their unlocking position;
simultaneously extracting the spinner nose and the ejector from the gripping device;
taking the spinner nose and the ejector to a storage area.

According to another aspect of the invention, the method for mounting at least one spinner nose of a gripping device comprises at least the following operations:
simultaneously gripping a spinner nose and an ejector mounted on said spinner nose and positioned in a storage area;
placing the spinner nose and the ejector on the support of the gripping device;
actuating the jaws of the gripping device to move them from their unlocking position to a locking position;
releasing the spinner nose and the ejector.

### BRIEF DESCRIPTION OF THE FIGURES

Further features and advantages of the invention will become apparent upon reading the detailed description which follows, for the understanding of which reference will be made to the appended drawings described briefly below.

FIG. 1 is a schematic general view of a container production facility seen from above;

FIG. 2 is a detailed view of the medallion of FIG. 1, showing a preform;

FIG. 3 is an overall view of a spinner;

FIG. 4 is a perspective view of a spinner nose and an ejector;

FIG. 5 is a view of the spinner nose;

FIG. 6 is a view of the ejector with the jaws in the unlocking position;

FIG. 7 is a view of the ejector with the jaws in the locking position;

FIG. 8 is a view of the clamp in an open position;

FIG. 9 is a view of the clamp in an intermediate position;

FIG. 10 is a view of the clamp in a position for gripping the spinner nose of the ejector.

### DETAILED DESCRIPTION OF THE INVENTION

In the remainder of the description, elements having an identical structure or similar functions will be designated by the same reference numeral.

The longitudinal, vertical and transverse orientations will be applied with reference to the trihedron (L, V, T) shown in the figures, this not being limiting.

By convention, the longitudinal and transverse directions are determined fixedly relative to the molding devices such that whether an element is in the open or closed position has no bearing on said orientations.

Use will also be made of the terms “front” and “rear” with reference to the longitudinal orientation, and “upper” and “lower” with reference to the vertical orientation and lastly “left” or “right” and “inner” or “outer” with reference to the transverse orientation, this not being limiting.

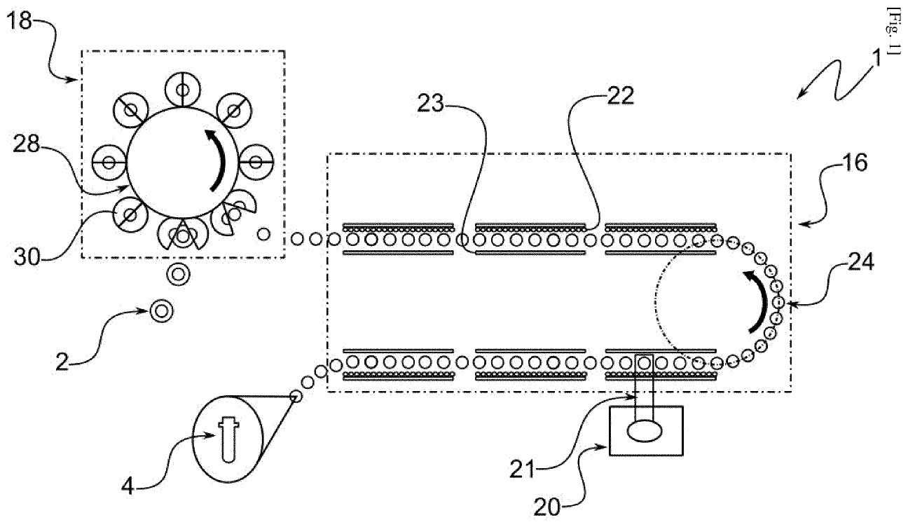

FIG. 1 schematically shows a facility 1 for the mass production of containers 2 made of thermoplastic material from preforms 4.

In the remainder of the description, the preforms 4 and the containers 2 move in the production facility along a circulation path from upstream to downstream. The preforms 4 are moved in a line along a heating path by conveying means which will be described in more detail below.

In this case, the containers 2 are bottles, without this being limiting. The thermoplastic material is in this case, for example, polyethylene terephthalate, hereinafter referred to by its acronym “PET”.

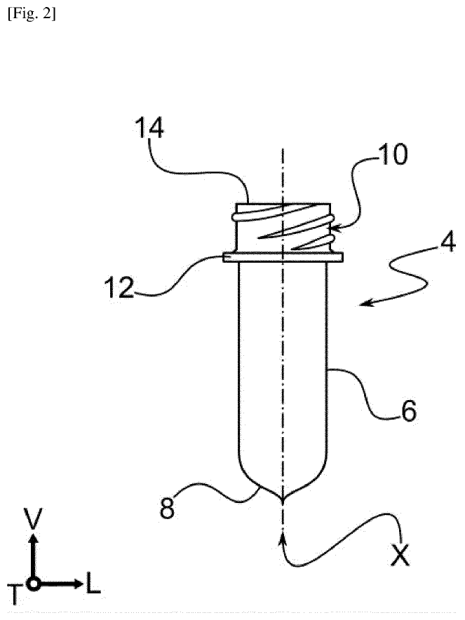

An example of such a preform 4 is shown in FIG. 2. The preform 4 has a main axis “X” shown vertically in the figure. It has a cylindrical body 6 with a tubular wall closed at one of its axial ends by a bottom 8, and open at its other end by a neck 10, also tubular. The neck 10 is delimited at the bottom by a collar 12 and at the top by an upper end edge referred to as a rim 14.

The neck 10 is generally in its final shape whereas the body 6 of the preform 4 is intended to undergo a relatively significant deformation to form the final container 2 during a forming step.

As shown in FIG. 1, the container manufacturing facility comprises at least one thermal conditioning unit 16, a forming unit 18 and a manipulator 20.

The thermal conditioning unit 16, also referred to as an oven, makes it possible to heat a succession of preforms 4 to a reference temperature. The reference temperature is selected so that the body 6 of each preform 4 at the outlet of the thermal conditioning unit 16 is in a malleable state allowing deformation of the body 6 of the heated preform in order to form the container 2 in the forming unit 18. The reference temperature is between the glass transition temperature and the crystallization temperature of the plastic material of the preform 4. In the case of PET, the reference temperature is around 110° for example. The reference temperature value may vary depending on the product with which the container 2 will be filled or depending on the container filling technique. Therefore, the reference temperature is different for hot filling or for a carbonated product for example.

According to the embodiment shown in FIG. 1, the thermal conditioning unit 16 is a tunnel oven, through which the preforms 4 are conveyed so as to be exposed to a plurality of heat radiation sources 22.

For this purpose, the thermal conditioning unit 16 comprises a means 24 for conveying the preforms 4 through the thermal conditioning unit 16 along a heating path extending between an inlet and an outlet of the thermal conditioning unit 16.

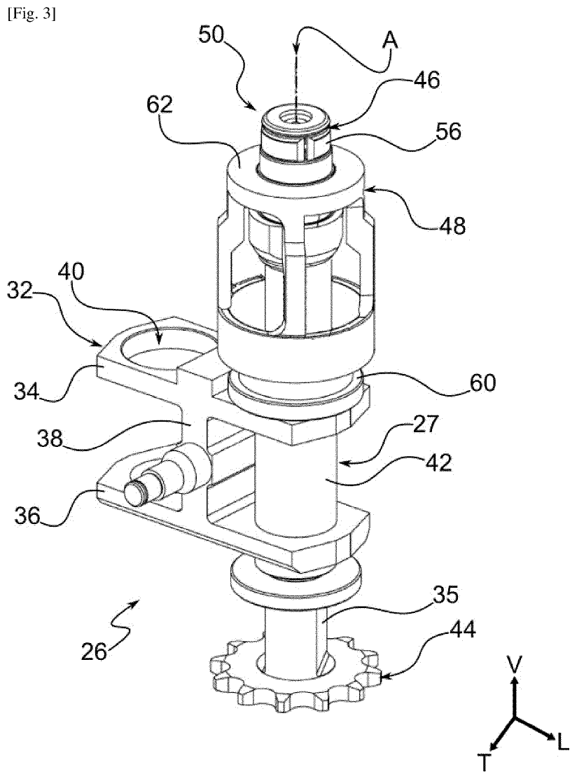

As shown in FIGS. 1 and 3, the conveying means 24 comprises a succession of gripping devices, each adapted to hold a preform 4, and mounted on a chain, moving along the heating path in the thermal conditioning unit 16.

In another embodiment that has not been shown, the conveying means 24 comprises for example a succession of gripping devices 26, each being adapted to hold a preform, and mounted on a linear motor shuttle traveling on a magnetic closed loop. The movement of each of these shuttles is controlled independently of one another by the control unit (not shown in the figures).

Each gripping device 26 is, for example, adapted to receive a preform 4 by fitting the neck 10 onto a spinner 27, shown in FIG. 3. Each spinner 27 is, for example, rotatable relative to the chain about an axis A of rotation coinciding with the main axis X of a preform 4 when the latter is held by the spinner 27.

The oven also comprises a heating cavity which comprises two side walls facing one another, at least one of these walls being the wall which supports several radiation sources 22, arranged one above the other and one beside the other facing the preforms.

In other words, the thermal conditioning unit 16 comprises a plurality of radiation sources 22 distributed along the heating path and at a height corresponding substantially to the height of the preforms such that the entire height of the body 6 of each preform is exposed to the radiation sources 22 over the path of the preform in the thermal conditioning unit 16. By rotating the preforms about their main axis X, the spinners 27 make it possible to uniformly expose the entire body 6 of the preforms to the radiation sources 22. In this particular embodiment, the radiation sources 22 are distributed on one side only of this path, and a reflective wall 23 is arranged on the other side of the heating path to reflect heat back onto the preforms.

In another embodiment not shown, the radiation sources 22 may be distributed on either side of the heating path without thereby departing from the scope of the invention.

Note also that the radiation sources 22 are arranged, where appropriate, so as not to subject the neck 10 to the heat emitted by the radiation sources 22. To be specific, as stated above, only the body 6 of the preform is formed to produce the container 2. Therefore, the neck 10 must not be deformed during forming and must not be heated. To avoid heating the neck 10, the oven 16 may comprise a ventilation device positioned in line with the necks to evacuate the heat likely to be absorbed by the necks.

Each radiation source 22 is formed by an incandescent bulb emitting infrared radiation.

In another embodiment, each radiation source 22 is a laser diode emitting infrared radiation.

In other words, each radiation source 22 is a laser (e.g. laser diodes) emitting in the infrared and laid out in a juxtaposed and/or superposed arrangement to form one or more matrices.

In another embodiment, each radiation source 22 is a microwave generator.

Then, once the preform 4 has been thermally conditioned in the thermal conditioning unit 16, it is transferred to the forming unit 18 to be formed therein.

The forming unit 18 for forming containers 2 from preforms 4 is made up of a forming wheel 28 rotating a plurality of forming stations from an inlet to an outlet, in which a succession of containers 4 are formed from the preforms 4, and then extracted, as shown in FIG. 1. The axis of rotation of the forming wheel 28 is, for example, substantially parallel to the main axis X of the preforms 4 when they are conveyed by the forming wheel 28.

Each blow molding station comprises a mold 30 forming a molding cavity having the shape of the container 2 to be formed and arranged to receive a preform 4 such that the body 6 of the preform extends inside the molding cavity.

The container manufacturing facility further comprises a manipulator 20 provided with a robotic arm 21 equipped at one of its ends with a clamp for dismantling spinners 27. The robotic arm 21 and clamp assembly is movable at least partially in line with the oven, in such a way as dismantle the spinners 27. The clamp will be described in more detail below in the description.

As shown in FIG. 3, the gripping device 26 comprises a support 32, also referred to as a link, which although shown individually in FIG. 3 is in fact integrated in a chain which includes many such links.

In this embodiment, the link 32, preferably made of metal (e.g. steel), comprises two superimposed branches 34, 36, which project laterally from a core 38. The branches 34, 36 are pierced with coaxial holes 40 which together define a main axis.

The gripping device 26 further comprises:
a mandrel 42 with an axis of revolution, is mounted in the holes 40 of the link 32 via a connection pivotably slidingly relative to the link 32. Thus, the main axis of the holes 40 and the axis of revolution of the mandrel 42 are coaxial;
a pinion 44 is rigidly secured rotationally to one of the free ends of the mandrel 42. The pinion 44 is advantageously formed on an end piece 45 in the form of a coil, force-fitted onto the mandrel 42;
a spinner 27 is mounted on the other end of the mandrel and comprises at least:
a spinner nose 46 which is removably attached to the mandrel, in this case by means of a bayonet (not shown in the figure). The spinner nose is intended to receive the neck 10 of the preform 4;
an ejector 48 is rigidly secured to the support 32 by removable attachment means which will be described in detail below in the description. This ejector 48 has a substantially cylindrical shape and comprises at one of its ends at least one surface referred to as a preform ejection surface.

The mandrel and the spinner nose 46 extend coaxially with the ejector 48 such that the free end of the spinner nose 46 projects from the ejector 48.

According to an alternative embodiment, not shown in the figures, the support 32 may be a linear motor also comprising at least one hole and in which the mandrel, the spinner, the pinion are mounted pivotably slidingly, without thereby departing from the scope of the invention.

As shown in FIGS. 3 to 5, the spinner 27 comprises the spinner nose 46 and the ejector 48.

The spinner 27 is a mobile apparatus intended to ensure the gripping of a preform 4 by its neck 10, and mounted on the link 32 with two degrees of freedom: a translation along the main axis A and a rotation about the main axis A.

In this embodiment, the spinner nose 46 comprises a radially expanding head 50 which is force-fitted inside the neck 10 of the preform 4, a radiator 52, and a shaft 54.

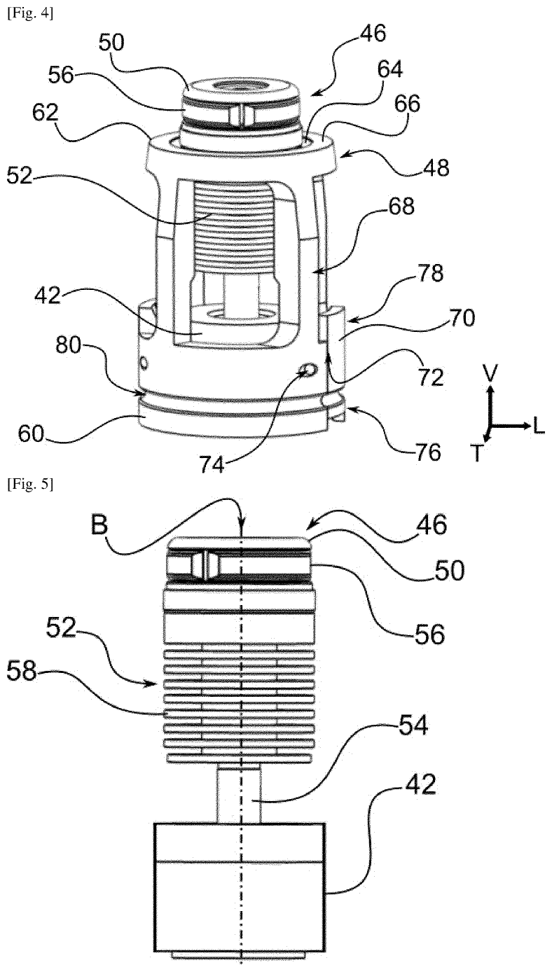

FIG. 5 shows the cylindrical head 50 of vertical axis “A” the outside diameter of which is slightly smaller than the inside diameter of the neck 10 such that there is a radial sliding clearance between the head 50 and the neck 10 when the head 50 is fitted into the neck 10.

The head 50 comprises rings 56 which are in the form of ring sectors. Each ring 56 is received such that it can slide radially in a radial housing of the head 50 between:
a position retracted toward the axis “A” of the head allowing vertical sliding of the spinner relative to the neck 10;
a radial expansion position in which they are capable of being pressed against the inner cylindrical face of the neck 10 to hold the preform 4 in place by friction.

The rings 56 are elastically urged toward their expansion position by means of an elastic ring which is interposed radially between the bottom of the housing made in the head and the ring 56.

The head 50 is delimited vertically toward the bottom by a segment of larger diameter delimiting an annular shoulder face which faces upwards and which forms a positioning face [N] against which the rim 14 is received in vertical abutment when the head 50 is fitted into the neck 10.

The radiator 52 is arranged under the head 50 and comprises fins 58 which have a generally cylindrical shape with a main vertical axis A, coaxial with the axis A of the head, and a diameter which is equivalent to the diameter of the segment with a larger diameter than the head.

The shaft 54 is attached at one of its ends to the radiator and head assembly, while the other end of the shaft 54 is removably attached to the mandrel, in this case by means of a bayonet (not shown in the figures).

The head, the radiator, the shaft and the mandrel are coaxial.

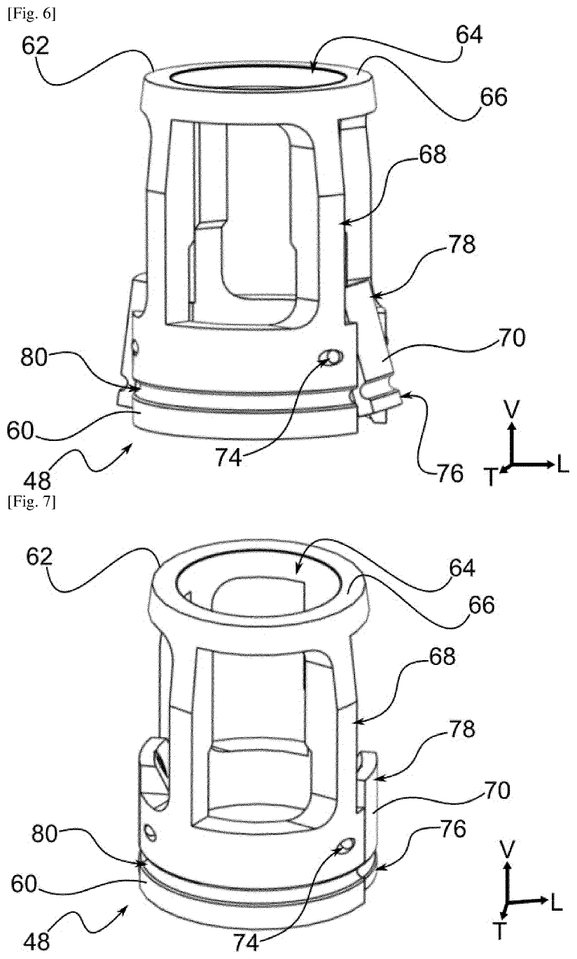

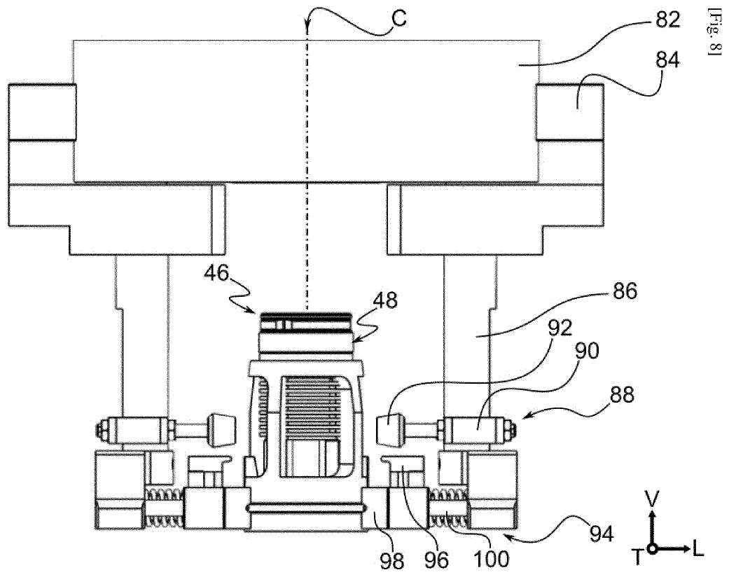

As shown in FIGS. 6 and 7, the ejector 48 comprises:
a roughly cylindrical base 60 of axis A, which includes a central hole [S], a plate 62 pierced with a central bore 64 and which defines an ejection face 66,
a series of legs 68 (four in this case) which connect the base 60 to the plate 62, and which define openings between them.

The hole [S] and the bore 64 are set back relative to a common axis.

The base 60 further comprises at least one attachment means also referred to as a jaw 70 which makes it possible to rigidly secure the ejector 48 to the support 32.

In the embodiment shown in FIGS. 6 and 7, these jaws 70 are two in number and diametrically opposite one another.

Each jaw 70 extends in a housing 72 made in the base 60 and pivots about an articulation axis 74 which is orthogonal to the axis 74 of the base 60.

Each jaw 70 comprises a first part 76 and a second part 78 extending on either side of the articulation axis 74.

The first part 76 is arranged below the articulation axis 74 and comprises male or female means adapted to interact with complementary female or male means rigidly secured to the support 32 or to the ejector (not shown in the figures).

The second part 78 is arranged above the articulation axis 74 and comprises a surface referred to as the actuating surface such that, by exerting pressure on and/or releasing the pressure on the actuating surface, each jaw 70 passes from its unlocking position (as shown in FIG. 6) to its locking position (as shown in FIG. 7) and vice versa.

The base 60 further comprises an annular groove 80 which is made both in the wall of the base 60 and in one of the parts of the jaw 70. This groove 80 makes it possible to accommodate an elastic return means (not shown in the figures) which ensures the position of the jaw 70 when it is not subjected to a clamp, and vice versa.

To change a spinner, particularly in the case of a change of preform 4 format, the spinner may be dismantled manually by an operator, or automatically by a manipulator 20 provided with a clamp for dismantling the spinners.

As schematically shown in FIG. 1, the manipulator 20 comprises a robotic arm 21 and a clamp (not shown in FIG. 1) intended to grip the spinner, that is to say, the ejector 48 and spinner nose 46 assembly simultaneously.

As shown in FIGS. 8 to 10, the clamp is positioned above the spinner to dismantle it from the support 32 and vice versa, to reassemble it on the support 32.

The clamp comprises a plinth 82 having the shape of a straight block with an axis C located in the center of its upper face. The robotic arm 21 is attached on the upper face of the plinth 82. The plinth 82 comprises at least one actuator (not shown in the figures) the movable parts 84 of which retract on the lateral faces of the straight block. The actuator may be pneumatic, such as a cylinder, or electric, such as a brushless electric motor.

Two branches referred to as main branches 86 are mounted movably, in particular in translation, relative to one another. Each main branch 86 is oriented vertically and parallel to the axis A of the plinth 82. Each main branch 86 is rigidly secured at one of its ends to the movable part 84 of the actuator.

Each main branch 86 comprises at the other end a first gripping means 88 adapted to grip the spinner nose 46. This gripping means is made up of a secondary branch 90 which extends from a first main branch 86 toward the second main branch 86. Each secondary branch 90 is orthogonal to the axis C of the plinth 82. Each secondary branch 90 comprises adjustment means for vertically positioning the first gripping means 88 relative to the main branch 86 so that each secondary branch 90 is opposite the spinner nose 46 to be gripped. The free end of this secondary branch 90 is provided with a tip 92, in particular a deformable material, for gripping the spinner nose 46 in the region of the radiator. This tip 92 is removably mounted relative to the secondary branch 90 in order to be removed in the event that it wears out.

A second gripping means 94 is located on the main branch 86 at the opposite end to the part rigidly secured to the actuator.

This second gripping means 94 is adapted to interact with the attachment means of the ejector 48 to move the jaws 70 from their locking position to an unlocking position. Each second gripping means 94 comprises a pusher 96 forming a radial protrusion toward the axis A intended to interact with the attachment means of the ejector 48 and in particular with the surface referred to as the actuating surface of the attachment means such that, by exerting pressure on and/or by releasing said pressure on the actuating surface, each jaw 70 passes from its unlocking position to its locking position and vice versa.

With reference to FIGS. 8 to 10, the pusher 96 comprises a rod extending parallel to the secondary branch 90 and adapted to move parallel to the latter, the free end of the pusher 96 comprising a surface adapted to bear on the jaw 70 of the attachment means.

The second gripping means 94 also comprises at least one pad 98 referred to as an ejector pad. This ejector pad 98 is adapted to grip the ejector 48 and hold the ejector 48 in a certain position before locking or unlocking the latter. For gripping purposes, the pad 98 has a shape complementary to the outer surface of the ejector. The pad 98 is rigidly secured to a rod 100 extending through a hole made in the main branch 86, an elastic means 102 being positioned between the main branch 86 and the pad 98 to dampen the movement of the pusher 96 during the movement of the branches.

The elastic means 102 consists of a helical spring extending around the rod 100 and of which a first end bears on the main branch 86 and of which the opposite end bears on the pad 98.

As shown in FIGS. 8 to 10, the pusher 96 is rigidly secured to the ejector pad 98 in such a way that it actuates the jaw 70 at the same time as the ejector is already gripped by the ejector pad 98.

Advantageously, although not shown in the figures, the second gripping means 94 comprises two guides extending parallel to the rod 100, on either side of the latter, rigidly secured to the main branch 86 and along which the ejector pad 98 is adapted to slide. These guides improve the quality of movement of the ejector pad 98.

By virtue of the clamp described above, the spinner, and in particular the ejector and the spinner nose 46 can be changed in an automated manner according to the method which will be described below.

In this regard, the invention also relates to an automated spinner-changing method.

As shown in FIGS. 1 and 8, a robotic arm 21 rigidly secured to a clamp as described previously, is positioned at the spinner to be dismantled. The clamp is then in the open position, that is to say that the main branches 86, the first gripping means, and the second gripping means are in a position spaced apart such that they are not in contact with the spinner to be gripped.

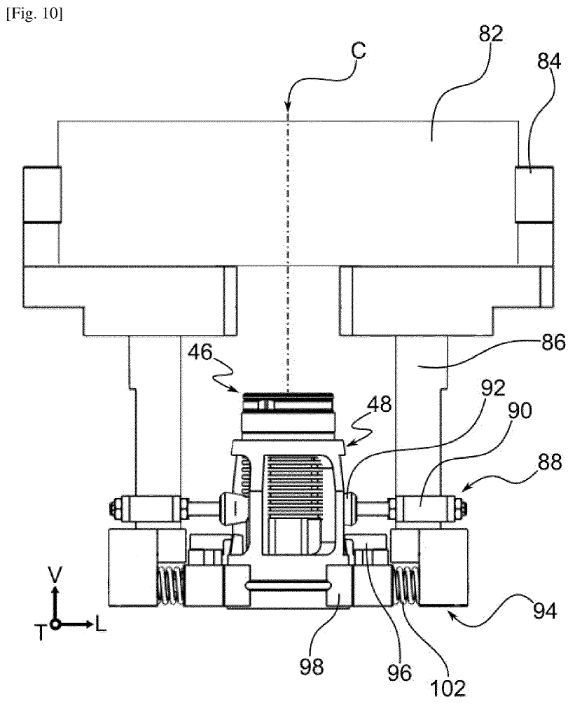

Next, the clamp grips a spinner nose 46 of the gripping device 26 to block it in rotation and in translation along its axis of revolution and actuates jaws 70 of the attachment means of the gripping device 26 to move them from their locking position to their unlocking position. As shown in FIG. 10, the clamp is in a gripping position. The main branches 86 have been moved so that the first gripping means 88 is engaged with the spinner nose 46 and the pushers 96 unlock the jaws 70 of the attachment means of the ejector.

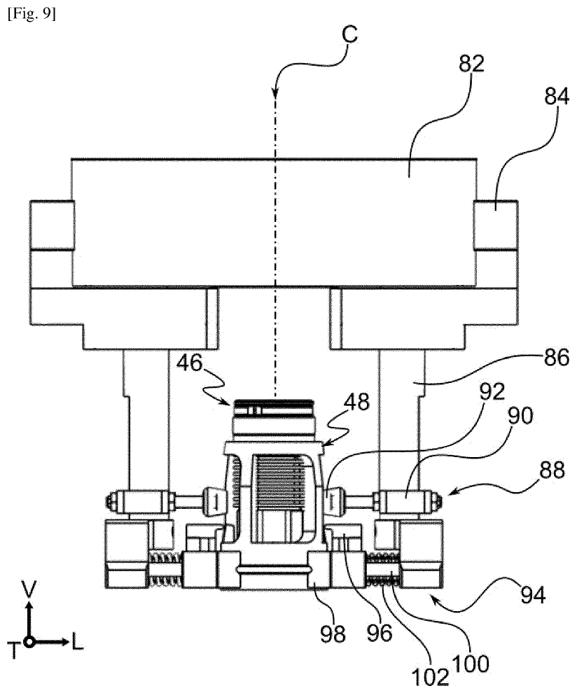

Advantageously, and as shown in FIG. 9, the clamp may be in an intermediate position. The main branches 86 have been moved so that the second gripping means 94, i.e. the ejector pad 98, is in contact with the ejector to immobilize same. By contrast, the first gripping means are not yet in contact with the spinner nose 46 and the pushers 96 have not yet unlocked the jaws 70 of the attachment means of the ejector 48.

The movement, in particular in translation, of the main branches 86, when gripping the spinner, allows the following three sequential steps: gripping of the ejector 48 by the ejector pad 98, gripping of the spinner nose 46 by the tip 92 of the secondary branch 90 and unlocking of the jaws 70 of the means for attaching the ejector to the support 32.

Lastly, the clamp simultaneously extracts the spinner nose 46 and the ejector from the gripping device 26 and places them in a storage area.

Advantageously, the method consists in carrying out various additional steps:
simultaneously gripping a spinner nose 46 and an ejector 48 mounted on said spinner nose and positioned in a storage area;
placing the spinner nose and the ejector on the support 32 of the gripping device 26; p1 actuating the jaws 70 of the gripping device 26 to move them from their unlocking position to a locking position;
releasing the spinner nose and the ejector.

Lastly, the spinner nose and ejector assembly is moved in a storage area.

1. A gripping device for gripping a preform of a container made of thermoplastic material in a thermal conditioning unit, wherein the device comprises:
a support with a hole of vertical axis A;
a mandrel with an axis of revolution B, wherein a first end of the mandrel is mounted in the hole of the support via a connection pivotably slidingly relative to said support, said vertical axis A of the support and the axis B of the mandrel thus being coaxial; and
a spinner mounted on a free opposite end of the mandrel, wherein the spinner comprises at least:
a spinner nose rigidly secured removably to the free opposite end of the mandrel, said spinner nose configured to receive a neck of the preform;
an ejector rigidly secured to the support by removable attachment means, the mandrel and the spinner nose extending coaxially with the ejector such that a free end of the spinner nose projects from said ejector, said ejector having a substantially tubular shape and comprising at one of its ends at least one ejection surface for ejecting said preform;
wherein said removable attachment means comprises at least one jaw rigidly secured to the ejector and/or to the support, each jaw comprising male or female means configured to interact with complementary female or male means rigidly secured to the support or respectively to the ejector, and at least one elastic means configured to keep the male or female means of the jaws in a locking position, in the female or male means of the support or respectively of the ejector.

2. The gripping device as claimed in claim 1, wherein each of the at least one jaws pivots about an articulation axis orthogonal to the mandrel of axis of revolution.

3. The gripping device as claimed in claim 1, wherein said jaw extends in a housing made in a peripheral wall of the ejector or the support when said jaw is in the locking position, and wherein all or part of said jaw projects from said housing in an unlocking position.

4. The gripping device as claimed in claim 1, wherein the removable attachment means comprises two jaws diametrically opposite one another.

5. The gripping device as claimed in claim 2, wherein each jaw comprises a first part and a second part extending on either side of the articulation axis, said first part comprising said male or female means configured to interact with complementary female or male means rigidly secured to the support or to the ejector and said second part comprising an actuating surface such that, by exerting pressure on and/or releasing said pressure on the actuating surface, each jaw passes from an unlocking position to the locking position and vice versa.

6. The gripping device as claimed in claim 1, wherein the elastic return means is an O-ring, a coiled annular spring, or a torsion spring.

7. The gripping device as claimed in claim 6, wherein a part of said elastic return means bears in a groove made in a peripheral wall of the ejector or the support.

8. A clamp adapted and configured to be rigidly secured to a robotic arm and to interact with a gripping device as claimed in claim 1, wherein the clamp comprises at least two main branches that are movable relative to one another and rigidly secured to at least one movable component of an actuator, each main branch comprising a first gripping means configured to grip said spinner nose and a second gripping means referred configured to interact with said jaws of the attachment means of the gripping device to move the jaws from the locking position to an unlocking position.

9. The clamp as claimed in claim 8, wherein the gripping means of each main branch comprises a secondary branch extending from a first main branch toward a second main branch, a free end of the secondary branch being configured to bear on the spinner nose so as to grip the second main branch.

10. The clamp as claimed in claim 9, wherein the free end of each secondary branch comprises an elastomer tip.

11. The clamp as claimed in claim 10, wherein the elastomer tip is rigidly secured removably to the free end of each secondary branch.

12. The clamp as claimed in claim 8, wherein the second gripping means of each main branch comprises a pusher configured to actuate the jaws of the attachment means of the gripping device.

13. The clamp as claimed in claim 8, wherein the second gripping means of each main branch comprises at least one ejector pad to which a pusher is rigidly secured, said ejector pad being configured to grip said ejector.

14. The clamp as claimed in claim 13, wherein the pusher is rigidly secured to the ejector pad and actuates the jaw simultaneously when the ejector is gripped by the ejector pad.

15. The clamp as claimed in claim 12, wherein said pusher comprises a rod extending parallel to a secondary branch, wherein the rod is configured to move parallel to the secondary branch, the free end of said pusher comprising a surface configured to bear on a corresponding jaw of the attachment means of the gripping device.

16. The clamp as claimed in claim 15, wherein said rod extends through a hole made in the main branch, an elastic means being positioned between the main branch and a pad to dampen the movement of the pusher.

17. The clamp as claimed in claim 16, wherein said elastic means consists of a helical spring extending around the rod and of which a first end bears on the main branch and of which the opposite end bears on the pad.

18. The clamp as claimed in claim 15, wherein the second gripping means comprise two guides extending parallel to the rod on either side of the rod, rigidly secured to the main branch and along which the ejector pad is configured to slide.

19. A method for dismantling at least one spinner nose of a gripping device as claimed in claim 1, the method comprising:
gripping the spinner nose of the gripping device to block the gripping device in rotation and in translation along an axis of revolution;
actuating the jaws of the gripping device to move the jaws from the locking position to an unlocking position;
simultaneously extracting the spinner nose and the ejector from the gripping device; and
taking the spinner nose and the ejector to a storage area.

20. A method for mounting at least one spinner nose of a gripping device as claimed in claim 1, comprising:
simultaneously gripping the spinner nose and the ejector mounted on said spinner nose and positioned in a storage area;
placing the spinner nose and the ejector on the support of the gripping device;
actuating the jaws of the gripping device to move the jaws from an unlocking position to the locking position; and
releasing the spinner nose and the ejector.
